(19) United States
(12) Patent Application Publication
(10) Pub. No.: US 2021/0233538 A1
(43) Pub. Date: Jul. 29, 2021

(54) AGENT SYSTEM, TERMINAL DEVICE, AND COMPUTER READABLE RECORDING MEDIUM

(71) Applicant: TOYOTA JIDOSHA KABUSHIKI KAISHA, Toyota-shi (JP)

(72) Inventor: Kohki TAKESHITA, Edogawa-ku (JP)

(73) Assignee: TOYOTA JIDOSHA KABUSHIKI KAISHA, Toyota-shi (JP)

(21) Appl. No.: 17/101,492

(22) Filed: Nov. 23, 2020

(30) Foreign Application Priority Data
Jan. 23, 2020 (JP) 2020-009263

(51) Int. Cl. G10L 17/06

(52) U.S. Cl. CPC G10L 17/06

(57) ABSTRACT

An agent system includes: a terminal device including a first processor including hardware, the first processor being configured to recognize spoken voice of a user, determine to which speech interaction agent among a plurality of speech interaction agents an instruction included in the spoken voice of the user is directed, and transfer the spoken voice of the user to an agent server configured to realize a function of the determined speech interaction agent; and an agent server including a second processor including hardware, the second processor being configured to recognize the spoken voice of the user which voice is transferred from the terminal device, and output a result of the recognition to the terminal device.

The present application claims priority to and incorporates by reference the entire contents of Japanese Patent Application No. 2020-009263 filed in Japan on Jan. 23, 2020.

### BACKGROUND

The present disclosure relates to an agent system, a terminal device, and a computer readable recording medium.

Japanese Laid-open Patent Publication No. 2018-189984 discloses a speech interaction method for using services of a plurality of speech interaction agents having different functions. In this speech interaction method, which speech interaction agent is to execute processing based on an input speech signal is determined based on a result of speech recognition processing and agent information.

### SUMMARY

There is a need for an agent system, a terminal device, and a computer readable recording medium capable of accurately calling a speech interaction agent having a function requested by a user in a case where services of a plurality of speech interaction agents are available.

According to one aspect of the present disclosure, there is provide an agent system including: a terminal device including a first processor including hardware, the first processor being configured to recognize spoken voice of a user, determine to which speech interaction agent among a plurality of speech interaction agents an instruction included in the spoken voice of the user is directed, and transfer the spoken voice of the user to an agent server configured to realize a function of the determined speech interaction agent; and an agent server including a second processor including hardware, the second processor being configured to recognize the spoken voice of the user which voice is transferred from the terminal device, and output a result of the recognition to the terminal device.

### BRIEF DESCRIPTION OF THE DRAWINGS

FIG. 1 is a view schematically illustrating an agent system and a terminal device according to an embodiment;

FIG. 2 is a block diagram schematically illustrating configurations of the agent system and the terminal device according to the embodiment; and

FIG. 3 is a flowchart illustrating an example of a processing procedure of a speech interaction method executed by the agent system, the terminal device, and an agent program according to the embodiment.

### DETAILED DESCRIPTION

An embodiment of the present disclosure will be described with reference to the drawings. Note that components in the following embodiment include what may be easily replaced by those skilled in the art or what is substantially the same.

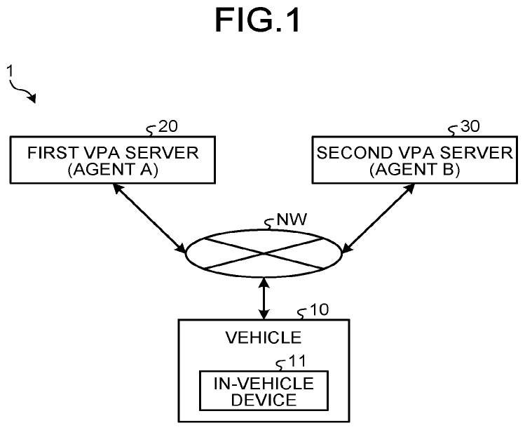

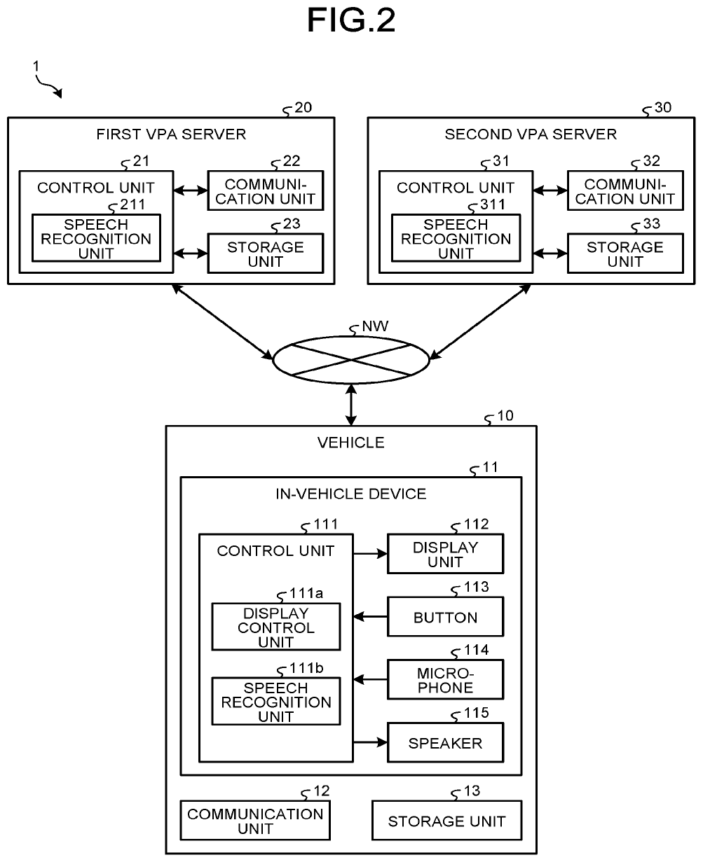

Configurations of the agent system and the terminal device will be described with reference to FIG. 1 and FIG. 2. The agent system, the terminal device, and the agent program are to provide a user with services of a plurality of speech interaction agents (hereinafter, referred to as “agent”).

Here, the “user” is a person that uses services of a plurality of agents through the terminal device. The terminal device in the present embodiment is assumed to be an in-vehicle device mounted on a vehicle. Thus, the user is, for example, an occupant including a driver of the vehicle. Note that the terminal device is not limited to the in-vehicle device mounted on the vehicle, and may be an information terminal device owned by the user, for example. Examples of this information terminal device include a mobile phone, a tablet terminal, a wearable computer, and a personal computer.

As illustrated in FIG. 1, an agent system 1 includes a vehicle 10 equipped with an in-vehicle device 11, a first virtual personal assistant (VPA) server 20, and a second VPA server 30. The terminal device is specifically realized by the in-vehicle device 11. The vehicle 10, the first VPA server 20, and the second VPA server 30 may communicate with each other through a network NW. This network NW includes, for example, an Internet network, a mobile phone network, and the like.

Although the agent system 1 in the present embodiment uses two VPA servers, the number of VPA servers may be three or more. Also, in the present embodiment, the first VPA server 20 is a server device to realize a function of an agent A, and the second VPA server 30 is a server device to realize a function of an agent B. The agent A and agent B may provide the same type of service (such as music streaming service) or may provide different types of services (for example, the agent A provides a music streaming service and the agent B provides a weather information service). Note that in the present embodiment, the agents A and B are collectively referred to as an “agent”, and the first VPA server 20 and the second VPA server 30 are collectively referred to as a “VPA server” or an “agent server”.

As illustrated in FIG. 2, the vehicle 10 includes an in-vehicle device 11, a communication unit 12, and a storage unit 13. The in-vehicle device 11 is a car navigation device mounted on the vehicle 10, for example. The in-vehicle device 11 includes a control unit 111, a display unit (display) 112, a button 113, a microphone 114, and a speaker 115.

More specifically, the control unit 111 includes a processor including a central processing unit (CPU), a digital signal processor (DSP), a field-programmable gate array (FPGA), and the like, and a memory (main storage unit) including a random access memory (RAM), a read only memory (ROM), and the like.

The control unit 111 realizes a function that meets a predetermined purpose by loading and executing a program, which is stored in the storage unit 13, in a work area of the main storage unit, and controlling each configuration unit and the like through execution of the program. The control unit 111 functions as a display control unit 111a and a speech recognition unit 111b through execution of the program stored in the storage unit 13.

The display control unit 111a controls display contents of the display unit 112. Based on an operation by a user, the display control unit 111a causes the display unit 112 to display a screen corresponding to the operation. Also, the display control unit 111a causes the display unit 112 to display predetermined information input from the first VPA server 20 and the second VPA server 30. Examples of the “predetermined information” include a recognition result of spoken voice of the user, and response data related to processing based on an instruction from the user.

Here, for example, in a case where the user instructs an agent (VPA server) to “play music”, “processing based on an instruction from the user” indicates processing in which the VPA server acquires music streaming data from a server to provide a music streaming service (hereinafter, referred to as “service server”) and performs a transmission thereof to the in-vehicle device 11. Also, “response data” transmitted from the VPA server to the in-vehicle device 11 at that time is music streaming data.

When the speech recognition unit 111b determines to which agent between the plurality of agents A and B an instruction included in the spoken voice of the user is directed, the display control unit 111a may cause the display unit 112 to display a name of the determined agent. This makes it possible to check to which agent the user gives an instruction. Also, even in a case where an instruction is delivered to an agent different from what is intended by the user, it is possible to take a measure such as correcting the instruction. Thus, convenience is improved.

The speech recognition unit 111b is a speech recognition engine that performs automatic speech recognition (ASR) processing and natural language understanding (NLU).

The speech recognition unit 111b recognizes spoken voice of the user which voice is input from the microphone 114, and determines to which agent between the plurality of agents A and B an instruction included in the spoken voice of the user is directed. Then, the speech recognition unit 111b transfers the spoken voice of the user to an agent server (first VPA server 20 or second VPA server 30) that realizes a function of the determined agent. Then, the speech recognition unit 111b acquires predetermined information (speech recognition result and response data) from the agent server.

More specifically, the speech recognition unit 111b converts the spoken voice of the user into text data, determines that an instruction is to an agent in a case where a phrase identifying the agent is included in the text data. Here, the “phrase identifying the agent” indicates a wake up phrase (WuP) to call the agent. Note that the wake up phrase is also called a “wake word”.

The speech recognition unit 111b may output a result of speech recognition processing as it is to the agent server (first VPA server 20 or second VPA server 30). In this case, the speech recognition unit 111b outputs a recognition result of spoken voice of a user to the agent server instead of the spoken voice of the user. Then, the speech recognition unit 111b acquires predetermined information (such as response data) from the agent server. As a result, a response speed of the agent server is improved since the speech recognition processing in the agent server may be omitted.

The display unit 112 includes, for example, a liquid crystal display (LCD), an organic EL display (OLED), or the like, and displays information under the control of the display control unit 111a. The button 113 is a button pressed by the user in speaking. The button 113 includes, for example, a push-type physical push button provided on a steering wheel or the like of the vehicle 10, or a virtual push button displayed on the display unit 112.

Here, there is a plurality of calling methods (starting method) for an agent in the present embodiment. For example, in a case of instructing the agent B (second VPA server 30) to provide weather information, the user speaks in a manner of (1) and (2) in the following.

(1) Speak “agent B, tell me the weather today”.

(2) Press button 113 and speak “tell me the weather today”.

(1) is a method of using a wake up phrase. The user speaks a phrase including a phrase identifying the agent B and an instruction for the agent B.

(2) is a method of using the button 113 instead of the wakeup phrase. Note that “pressing the button 113 and speaking” includes two patterns that are a case of pressing the button 113 and starting speaking after a release of the button (push-to-talk/tap-to-talk), and a case of speaking with the button 113 being kept pressed and releasing the button 113 after the speech is over (hold-to-talk). In such a manner, it is possible to omit the wake up phrase by pressing the button 113 and speaking.

Also, when using an agent, it is possible to call another agent through a certain agent. For example, in a case of instructing the agent B (second VPA server 30) to provide weather information through the agent A (first VPA server 20), the user speaks in a manner of (3) in the following.

(3) Speak “agent A and agent B, tell me the weather today”.

Here, in the case of (3), the spoken voice of the user includes wake up phrases of a plurality of agents. Thus, as compared with (1) and (2), there is a high possibility that an agent not intended by the user is called. Thus, in the agent system 1, the terminal device, and the agent program, to which agent an instruction from the user is directed is determined on a side of the in-vehicle device 11, and the spoken voice of the user is transferred to a VPA server based on a result of the determination.

The microphone 114 is an input unit that receives a speech input from the user. The microphone 114 is used, for example, when the user gives an instruction for an agent (VPA server). The speaker 115 is an output unit that outputs sound to the user. The speaker 115 is used when the agent responds to the user based on an instruction from the user, for example.

The communication unit 12 includes, for example, a data communication module (DCM) and the like, and performs communication with the first VPA server 20 and the second VPA server 30 by wireless communication through the network NW.

The storage unit 13 includes a recording medium such as an erasable programmable ROM (EPROM), a hard disk drive (HDD), or a removable medium. Examples of the removable medium include a universal serial bus (USB) memory, and disc recording media such as a compact disc (CD), a digital versatile disc (DVD), and a Blu-ray (registered trademark) disc (BD). Also, the storage unit 13 may store an operating system (OS), various programs, various tables, various databases, and the like. When necessary, the storage unit 13 stores, for example, data of interaction contents of the user, data of a recognition result of spoken voice of the user, and the like.

The first VPA server 20 includes a control unit 21, a communication unit 22, and a storage unit 23. Physical configurations of the communication unit 22 and the storage unit 23 are similar to those of the communication unit 12 and the storage unit 13.

More specifically, the control unit 21 includes a processor including a central processing unit (CPU), a digital signal processor (DSP), a field-programmable gate array (FPGA), and the like, and a memory (main storage unit) including a random access memory (RAM), a read only memory (ROM), and the like. The control unit 21 realizes a function of a speech interaction agent by executing a program of the speech interaction agent which program is stored in the storage unit 23. The control unit 21 also functions as a speech recognition unit 211 through execution of a program stored in the storage unit 23.

The speech recognition unit 211 has a function similar to that of the speech recognition unit 111b, recognizes spoken voice of a user which voice is transferred from the in-vehicle device 11, and outputs predetermined information (speech recognition result and response data) to the in-vehicle device 11.

The speech recognition unit 211 may accumulate interaction contents of a user as preference information of the user in the storage unit 23, and may perform processing in consideration of the preference information of the user when performing processing based on a recognition result of spoken voice of the user which voice is transferred from the in-vehicle device 11. For example, in a case where the user frequently instructs the agent A to play music of a specific genre (such as classical music), the speech recognition unit 211 accumulates information “a favorite music genre of the user: classical music” as preference information in the storage unit 23. Then, in a case where the user instructs the agent A to “play music”, the speech recognition unit 211 acquires classical music streaming data from the service server and performs a transmission thereof to the in-vehicle device 11. As a result, it is possible to improve convenience since a service that suits a preference of the user may be received.

The storage unit 23 stores a program of a speech interaction agent realized by the first VPA server 20. Also, when necessary, the storage unit 23 stores, for example, data of interaction contents of the user, data of a recognition result of spoken voice of the user, and the like. Note that these pieces of information may be deleted from the storage unit 23 after use from a viewpoint of privacy protection.

The second VPA server 30 includes a control unit 31, a communication unit 32, and a storage unit 33. Physical configurations of the control unit 31, the communication unit 32, and the storage unit 33 are similar to those of the control unit 21, the communication unit 12, and the storage unit 13. The control unit 31 realizes a function of a speech interaction agent by executing a program of the speech interaction agent which program is stored in the storage unit 33. The control unit 31 also functions as a speech recognition unit 311 through execution of a program stored in the storage unit 33.

The speech recognition unit 311 has a function similar to that of the speech recognition unit 111b, recognizes spoken voice of a user which voice is transferred from the in-vehicle device 11, and outputs predetermined information (speech recognition result and response data) to the in-vehicle device 11. Similarly to the speech recognition unit 211, the speech recognition unit 311 may accumulate interaction contents of a user as preference information of the user in the storage unit 33, and may perform processing in consideration of the preference information of the user when performing processing based on a recognition result of spoken voice of the user which voice is transferred from the in-vehicle device 11. As a result, it is possible to improve convenience since a service that suits a preference of the user may be received.

The storage unit 33 stores a program of a speech interaction agent realized by the second VPA server 30. Also, when necessary, the storage unit 33 stores, for example, data of interaction contents of the user, data of a recognition result of spoken voice of the user, and the like. Note that these pieces of information may be deleted from the storage unit 33 after use from a viewpoint of privacy protection.

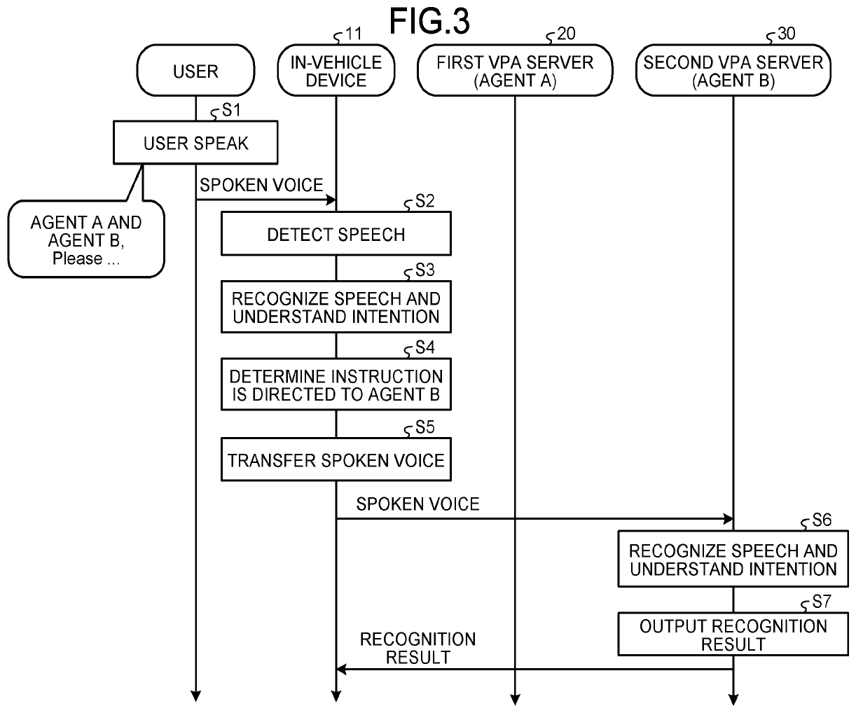

A processing procedure of the speech interaction method executed by the agent system 1 and the terminal device will be described with reference to FIG. 3. In the following, a speech interaction method of a case where a user calls another agent via a specific agent will be described. Also, for convenience of description, a step in which a user speaks is also illustrated in a flowchart of the speech interaction method in FIG. 3.

First, when a user speaks “agent A and agent B, please . . . ” (Step S1), data of the spoken voice is input into the in-vehicle device 11 through the microphone 114. Subsequently, the speech recognition unit 111b of the in-vehicle device 11 detects the speech of the user (Step S2), and performs speech recognition processing and intention understanding processing (Step S3).

The speech recognition unit 111b determines that the instruction is directed to the agent B (Step S4), and transfers the spoken voice of the user to the second VPA server 30 (Step S5). Subsequently, the speech recognition unit 311 of the second VPA server 30 performs speech recognition processing and intention understanding processing (Step S6), and outputs a recognition result thereof to the in-vehicle device 11 (Step S7).

Note that the following processing is performed in a case where the user speaks “agent B and agent A, please . . . ” in Step S1, for example. The speech recognition unit 111b detects the speech of the user in Step S2, and performs speech recognition processing and intention understanding processing in Step S3. Subsequently, the speech recognition unit 111b determines in Step S4 that the instruction is directed to the agent A, and transfers the spoken voice of the user to the first VPA server 20 in Step S5. Subsequently, the speech recognition unit 211 of the first VPA server 20 performs speech recognition processing and intention understanding processing in Step S6, and outputs a recognition result to the in-vehicle device 11 in Step S7.

According to the agent system 1, the terminal device, and the agent program of the above-described embodiment, to which agent an instruction from a user is directed is determined on a side of the in-vehicle device 11, and spoken voice of the user is transferred to a VPA server based on a result of the determination. As a result, since it is possible to accurately call an agent having a function requested by a user when services of a plurality of agents having different functions are used, a service expected by the user may be received.

For example, in the agent system 1, the terminal device, and the agent program according to the embodiment, in a case where a user instructs to “play music”, the VPA servers (first VPA server 20 and second VPA server 30) acquire music streaming data from a service server and perform a transmission thereof to the in-vehicle device 11. Instead of this method, a VPA server may control a service server and cause the service server to directly transmit music streaming data to an in-vehicle device 11.

According to the present disclosure, it is possible to accurately call a speech interaction agent having a function requested by a user when services of a plurality of speech interaction agents having different functions are used.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An agent system comprising:
a terminal device comprising
a first processor comprising hardware, the first processor being configured to
recognize spoken voice of a user,
determine to which speech interaction agent among a plurality of speech interaction agents an instruction included in the spoken voice of the user is directed, and
transfer the spoken voice of the user to an agent server configured to realize a function of the determined speech interaction agent; and
an agent server comprising
a second processor comprising hardware, the second processor being configured to
recognize the spoken voice of the user which voice is transferred from the terminal device, and
output a result of the recognition to the terminal device.

2. The agent system according to claim 1, wherein the second processor is configured to:
recognize the spoken voice of the user which voice is transferred from the terminal device;
perform processing based on a result of the recognition; and
output response data related to the processing to the terminal device.

3. The agent system according to claim 1, wherein
the first processor is configured to output a recognition result of the spoken voice of the user to the agent server instead of the spoken voice of the user, and
the second processor is configured to
perform processing based on the recognition result of the spoken voice of the user which result is transferred from the terminal device, and
output response data related to the processing to the terminal device.

4. The agent system according to claim 1, wherein
the terminal device includes a display, and
the first processor is configured to cause, when the determining to which speech interaction agent among the plurality of speech interaction agents the instruction included in the spoken voice of the user is directed, the display to display a name of the determined speech interaction agent.

5. The agent system according to claim 3, wherein the second processor is configured to:
accumulate interaction contents of the user as preference information of the user in a storage unit, and
perform, when performing the processing based on the recognition result of the spoken voice of the user which result is transferred from the terminal device, processing in consideration of the preference information of the user.

6. The agent system according to claim 1, wherein the first processor is configured to:
convert the spoken voice of the user into text data; and
determines, in a case where a phrase identifying a speech interaction agent is included in the text data, the instruction is for the speech interaction agent.

7. The agent system according to claim 1, wherein the spoken voice of the user includes a phrase identifying a speech interaction agent, and an instruction for the speech interaction agent.

8. The agent system according to claim 7, wherein the terminal device includes a button pressed by the user in speaking.

9. The agent system according to claim 1, wherein the terminal device is an in-vehicle device mounted on a vehicle.

10. The agent system according to claim 1, wherein the terminal device is an information terminal device owned by the user.

11. A terminal device comprising a processor comprising hardware, wherein the processor is configured to:
recognize spoken voice of a user, determines to which speech interaction agent among a plurality of speech interaction agents an instruction included in the spoken voice of the user is directed;
transfer the spoken voice of the user to an agent server that realizes a function of the determined speech interaction agent; and
acquire a recognition result of the spoken voice of the user from the agent server.

12. The terminal device according to claim 11, wherein the processor is configured to:
output a recognition result of the spoken voice of the user to the agent server instead of the spoken voice of the user; and
acquire response data related to processing based on the recognition result of the spoken voice of the user from the agent server.

13. The terminal device according to claim 11, further comprising a display, wherein
the processor is configured to cause, when determining to which speech interaction agent among the plurality of speech interaction agents the instruction included in the spoken voice of the user is directed, the display to display a name of the determined speech interaction agent.

14. The terminal device according to claim 11, wherein the processor is configured to:
convert the spoken voice of the user into text data; and
determine, in a case where a phrase identifying a speech interaction agent is included in the text data, the instruction is for the speech interaction agent.

15. The terminal device according to claim 11, wherein the spoken voice of the user includes a phrase identifying a speech interaction agent, and an instruction for the speech interaction agent.

16. The terminal device according to claim 15, further comprising a button pressed by the user in speaking.

17. The terminal device according to claim 11, wherein the terminal device is an in-vehicle device mounted on a vehicle.

18. The terminal device according to claim 11, wherein the terminal device is an information terminal device owned by the user.

19. A non-transitory computer-readable recording medium on which an executable program is recorded, the program causing a processor of a computer to execute:
recognizing spoken voice of a user, determining to which speech interaction agent among a plurality of speech interaction agents an instruction included in the spoken voice of the user is directed; and
transferring the spoken voice of the user to an agent server that realizes a function of the determined speech interaction agent.

20. The non-transitory computer-readable recording medium according to claim 19, wherein the program causes the processor to execute
outputting a recognition result of the spoken voice of the user to the agent server instead of the spoken voice of the user; and
acquiring response data related to processing based on the recognition result of the spoken voice of the user from the agent server.
